(19) United States
(12) Patent Application Publication
(10) Pub. No.: US 2012/0047564 A1
(43) Pub. Date: Feb. 23, 2012

(54) SECURITY SYSTEM AND METHOD

(75) Inventor: Shih-Liang Liu, Sandton (ZA)

(73) Assignee: SETCOM (PTY) LTD., Johannesburg, ZA (ZA)

(21) Appl. No.: 13/318,155

(22) PCT Filed: May 13, 2010
(86) PCT No.: PCT/IB10/52131

§ 371 Date: Oct. 31, 2011

(30) Foreign Application Priority Data
May 15, 2009 (ZA) 2009/03362

(51) Int. Cl. H04L 9/32; G06F 21/00

(52) U.S. Cl. 726/6

(57) ABSTRACT

A method of operating a security system includes accessing a database and obtaining a user PIN. A normal keypad is defined in which a plurality of alphanumeric characters are displayed in defined normal positions. A scrambled keypad is also defined including the PIN so that at least some of a plurality of alphanumeric characters are displayed on the scrambled keypad in positions which are different to the positions in which they would be displayed in the defined normal keypad. In addition, for each of the alphanumeric characters of the PIN the alphanumeric character which is normally displayed in the normal keypad in the position in which the alphanumeric characters of the PIN are displayed in the scrambled keypad is determined thereby to arrive at a scrambled PIN Data defining the scrambled keypad is then transmitted to a user over a first communications network.

### BACKGROUND OF THE INVENTION

THIS invention relates to a security system, particularly to a security system for receiving security codes, and to a method of operating the same.

Transactions such as online financial transactions via the Internet to purchase goods and/or services often require a user or customer to enter their banking details on their computing device for example a PC (Personal Computer) for transmission over the Internet in order to pay a particular vendor for purchased goods and/or services. The banking details typically comprise information indicative of the financial institution or bank and an associated bank account which the user wants to pay the vendor from.

More importantly, part of their banking details comprises a unique PIN (Personal Identification Number) code associated with the bank account of the user. The PIN code is typically a numeric or alphanumeric security PIN code which the user would enter via their keyboard or preferably keypad to authorize payment to other parties for example to the vendor for goods and/or services. It follows that the PIN entered by the user is typically forwarded to the relevant bank which would in turn authorize payment to the vendor accordingly.

Entering the unique PIN code via the keypad and even forwarding the received PIN code in the abovementioned fashion is problematic in that it opens the door for fraud. In particular, whilst typing or keying in the unique PIN, the user is prey to fraudsters who are able to obtain the unique PIN by way of keyloggers instead or in addition to simply peeking at the PIN entered. Screen-scrapper programs are also used by fraudsters to determine the PIN entered by the user. With the PIN obtained, fraudsters can make use thereof to access bank accounts of the users fraudulently for their own benefit.

It is therefore an object of the present invention to provide a method and a system at least to address the abovementioned problems.

### SUMMARY OF THE INVENTION

According to a first aspect of the invention there is provided a method of operating a security system, the method comprising:
accessing a database and obtaining a user PIN;
defining a normal keypad in which a plurality of alphanumeric characters are displayed in defined normal positions;
defining a scrambled keypad including the PIN so that at least some of a plurality of alphanumeric characters are displayed on the scrambled keypad in positions which are different to the positions in which they would be displayed in the defined normal keypad;
determining for each of the alphanumeric characters of the PIN the alphanumeric character which is normally displayed in the normal keypad in the position in which the alphanumeric characters of the PIN are displayed in the scrambled keypad thereby to arrive at a scrambled PIN;
transmitting data defining the scrambled keypad to a user over a first communications network so that the scrambled keypad can be displayed to the user; and
receiving a PIN entered by a user using the scrambled keypad wherein the received PIN is made up of alphanumeric characters of a normal keypad corresponding to keys selected by the user based on the displayed scrambled keypad.

The method may further comprise checking that the received PIN is correct and authorizing a transaction only if the received PIN is correct.

The method may further comprise receiving an input message from a user via a second communication channel, the input message relating at least to a transaction which requires a PIN associated with the user.

The input message may comprise at least information to identify the user.

In one example, the method includes determining an identity of the user from the received input message.

The PIN may be a PIN associated with a bank account of the user.

In one embodiment, the received PIN is received via a second communication network such as a cellular or mobile telecommunication network.

The method may also include transmitting the data defining the scrambled keypad to a cellular or mobile telephone associated with the user.

The received PIN is preferably checked for correctness by comparing the received PIN with a scrambled PIN stored in a memory or by converting the received PIN using the scrambled keypad sent to the user and then comparing the converted received PIN with the PIN stored in the database.

According to a second aspect of the invention there is provided a security system, the system comprising:
a database;
a processor to:
   access the database and obtain a user PIN define a normal keypad in which a plurality of alphanumeric characters are displayed in defined normal positions;
   define a scrambled keypad including the PIN so that at least some of a plurality of alphanumeric characters are displayed on the scrambled keypad in positions which are different to the positions in which they would be displayed in the defined a normal keypad; and
   determine for each of the alphanumeric characters of the PIN the alphanumeric character which is normally displayed in the normal keypad in the position in which the alphanumeric characters of the PIN are displayed in the scrambled keypad thereby to arrive at a scrambled PIN;
a transmitter to transmit data defining the scrambled keypad to a user over a first communications network so that the scrambled keypad can be displayed to the user; and
a receiver module to receive a PIN entered by a user using the scrambled keypad wherein the received PIN is made up of alphanumeric characters of a normal keypad corresponding to keys selected by the user based on the displayed scrambled keypad.

The processor may further comprise checking that the received PIN is correct.

In one example embodiment, the processor further authorizes the transaction only if the received PIN is correct.

The system may also include a message receiving module for receiving an input message from a user via a second communication channel, the input message relating at least to a transaction which requires a PIN associated with the user.

The input message may comprise at least information to identify the user.

In addition, the processor may determine an identity of the user from the received input message.

The PIN may be a PIN associated with a bank account of the user.

In one example, the received PIN is received via a second communication network such as a cellular or mobile telecommunication network.

The processor preferably checks the received PIN for correctness by comparing the received PIN with a scrambled PIN stored in a memory or by converting the received PIN using the scrambled keypad sent to the user and then comparing the converted received PIN with the PIN stored in the database.

### BRIEF DESCRIPTION OF THE DRAWINGS

FIG. 1 shows a schematic drawing of a network incorporating a system in accordance with an example embodiment;

FIG. 2 shows a schematic drawing of the system of FIG. 1 in greater detail;

FIG. 3 shows a flow diagram of a method in accordance with an example embodiment;

FIG. 4 shows an example illustration of an identification message transmitted to a user in accordance with an example embodiment;

FIG. 5 shows an example illustration of a security message in accordance with an example embodiment;

FIG. 6 shows an example illustration of a code receiving message transmitted to a user in accordance with an example embodiment; and

FIG. 7 shows an example illustration of a preferred embodiment of a code receiving message transmitted to a user in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

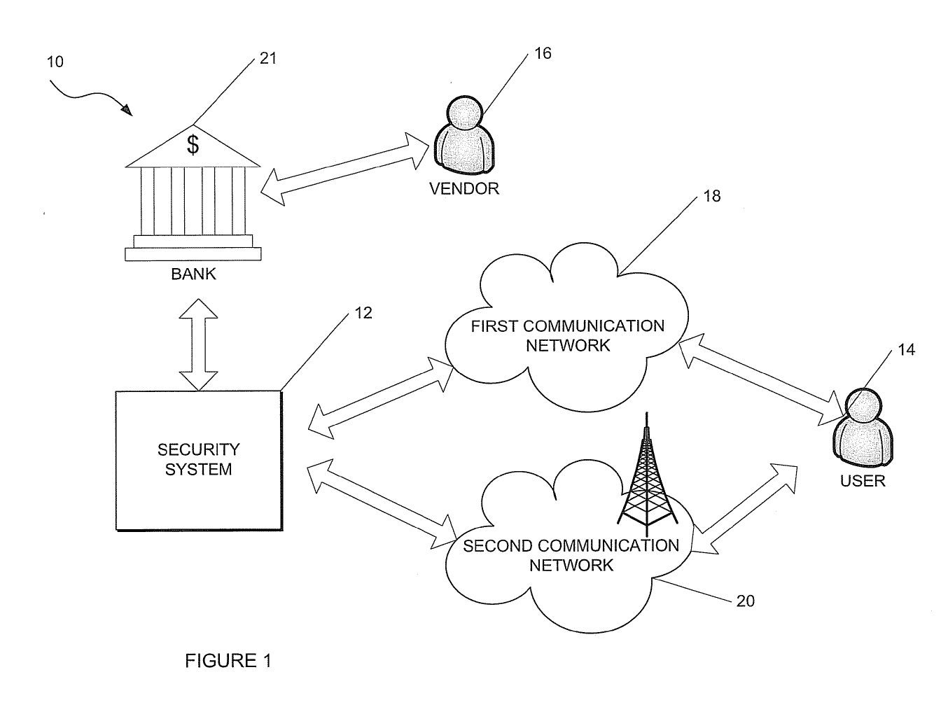

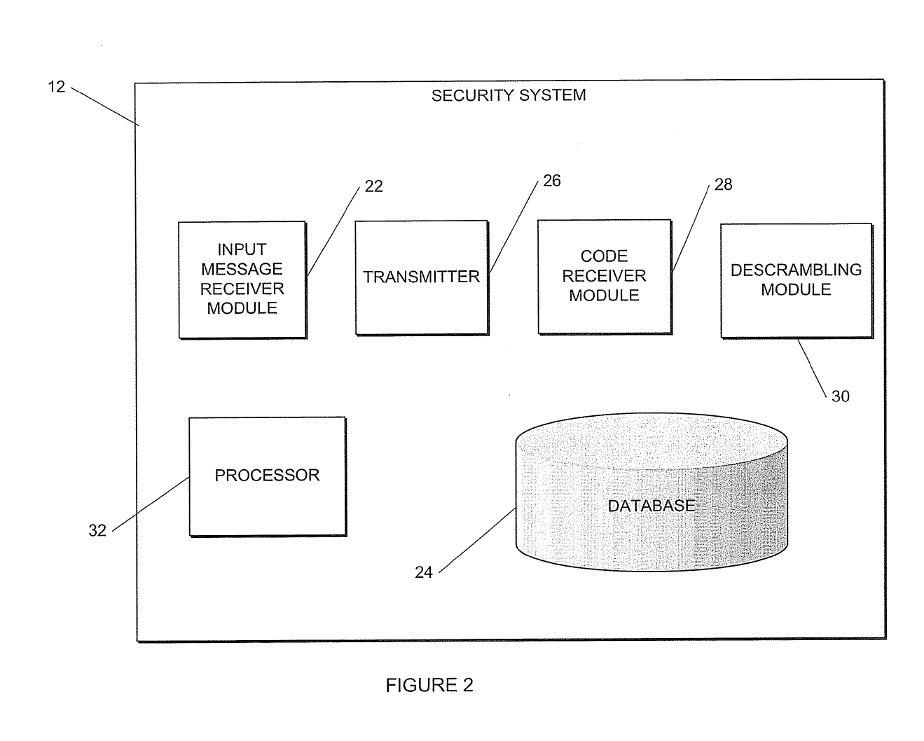

Referring to FIGS. 1 and 2 of the drawings where a network in accordance with an example embodiment is generally indicated by reference numeral 10. The network 10 preferably comprises a security system 12, in accordance with an example embodiment, for at least facilitating a more secure transaction between a user or customer 14 and a vendor 16 of goods and/or services over a first communication channel or network 18. It will be appreciated that the network 10 may comprise a plurality of users 14 and vendors 16. However, only one user 14 and vendor 16 are shown for ease of illustration.

“Transaction” in the context of the specification may be understood in a broad sense to include any type of operation which requires a code from the user 14 in order to proceed. For example, the transaction may be a login to a website such as an Internet Banking website, computer system, or the like. What is relevant is that there must be a security code required from the user 14 to access the website, computer system, or the like.

The first communication network 18 is typically a packet-switched data network which forms part of the Internet for example. It follows that for the present discussion, the transaction may be a web-based financial transaction between the user 14 and the vendor 16 for goods and/or services offered for sale by the vendor 16. The system 12 may include a modem to allow the system 12 to communicate via the network 18 with a computing device of the user 14, for example a PC (Personal Computer) associated with the user 14.

The system 12 is also arranged to communicate with the user 14 via a second communication channel or network 20. The second communication network 20 is typically a mobile or cellular telecommunication network. It follows that the system 12 may include one or more of a GSM (Global System for Mobile communications), GPRS (General Packet Radio Service), 3G, UMTS (Universal Mobile Telecommunications System) module, or the like to allow the system 12 to communicate via the network 20 with a mobile computing device of the user 14, for example a cellular or mobile telephone associated with the user 14.

It will be understood that the networks 18 and 20 may be any other type of communication channels or networks instead or in addition to those presently discussed such as a PSTN (Public Switched Telephone Network), or the like. What is preferred is that the networks 18 and 20 be different from each other thereby advantageously increasing the level of security of the system 12. In this light, in other example embodiments, the network 20 may be the packet-switched data network and network 18 may be a cellular telecommunication network.

This does not preclude the networks 18 and 20 from being the same or for forming part of each other respectively, for example network 20 may be a part of network 18, or vice versa.

Turning to FIG. 2 of the drawings, the security system 12 typically comprises a plurality of components or modules which correspond to the functional tasks to be performed by the security system 12. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices in for example the communication network 18 or network 20 such that the security system 12 may be operable to use the functionality provided by a module from within the communication network 18 or network 20.

In particular, the security system 12 comprises an input message receiver module 22 arranged to receive an input message from the user 14 via the first communication network 18 typically from a PC for example of the user.

The input message is typically a message relating at least to the transaction between the vendor 16 and the user 14 for goods and/or services which the user 14 purchases from the vendor 16 online. This message may be for initiating the transaction or in other words initiating payment for purchased goods and/or services typically from a bank account associated with the user 14 at a bank 21 to the vendor 16. It will be appreciated that the financial transaction requires a unique security code for example a PIN (Personal Identification Number) code associated with the bank account of user 14 in order to facilitate the transaction. The PIN code is an alphanumeric or preferably numeric code which serves at least to authorize payment to the vendor 16 for goods and/or services purchased.

The system 12 is typically arranged to communicate with the bank 21. In other example embodiments, the system 12 may be provided at the bank 21 to facilitate more secure transactions.

The system 12 may also be provided at the vendor 14 or even at a user 14 (not shown).

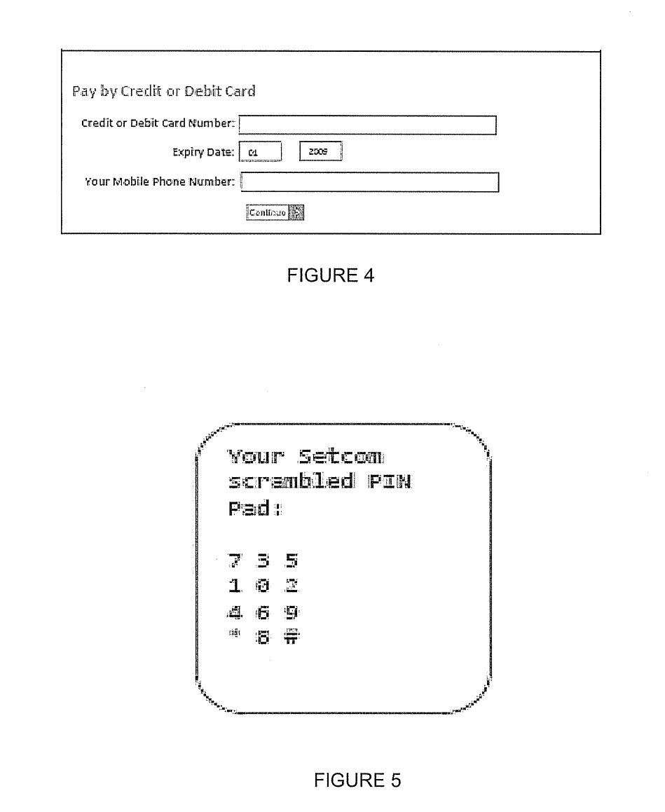

In any event, the input message may be received in response to prompting the user 14 for identification information in order to process payment to the vendor 16. The system 12 may be arranged to generate and transmit an identification message via the first communication network 18 to prompt the user 14 for the identification information. An example illustration of such an identification message is illustrated in FIG. 4. It will be noted that identification information which the user 14 is prompted for may include their credit or debit card number of a credit or debit card associated with a corresponding bank account/s at the bank 21, the expiry date of the credit or debit card, and the mobile telephone number or MSISDN (Mobile Subscriber Integrated Service Digital Network) number of a mobile or cellular telephone associated with the user 14 in order to process the transaction.

In other example embodiments, the identification information associated with the user 14 may be stored in a database 24.

The system 12 typically by way of processor 32 accesses a database 24 and obtains a user PIN.

In addition, a processor 32 defines a normal keypad in which a plurality of alphanumeric characters are displayed in defined normal positions.

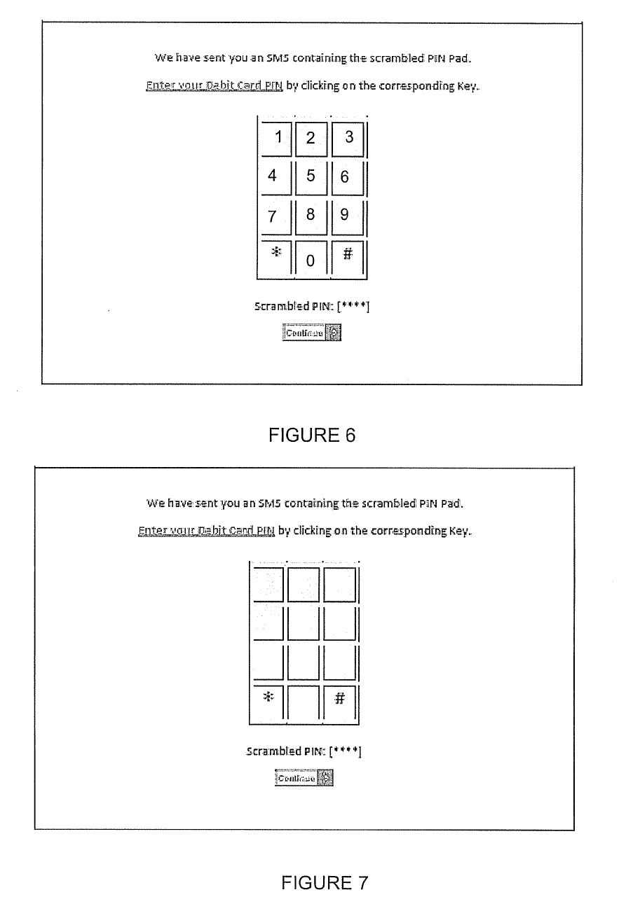

The processor 32 then defines a scrambled keypad including the PIN so that at least some of a plurality of alphanumeric characters are displayed on the scrambled keypad in positions which are different to the positions in which they would be displayed in the defined normal keypad. In one example the normal keypad is the kind of keypad normally displayed on a telephone or mobile telephone with numbers 0-9 displayed thereon, an example of which is illustrated in FIG. 6.

The processor 32 then stores in a memory for each of the alphanumeric characters of the PIN the alphanumeric character which is normally displayed in the normal keypad in the position in which the alphanumeric characters of the PIN are displayed in the scrambled keypad thereby to arrive at a scrambled PIN.

Transmitter 26 is used to transmit data defining the scrambled keypad to a user over a first or a second communications network so that the scrambled keypad can be displayed to the user.

In one example embodiment, the data transmitted is an SMS (Short Message Service) message. It follows that the transmitter 26 is arranged to communicate with the mobile telephone of the user 14 via the network 20. Use of the second communication network 20 to transmit the data advantageously increases the security of the system 12 as there is less opportunity for fraudsters to obtain the PIN code of the user 14.

The data message may be a TURing message, or the like. It will be noted that in other example embodiments (not discussed) where the second communication network 20 is part of the first communication network 18, the data message is typically transmitted to the PC of the user 14 for example.

The data conveniently comprises text data arranged in a format of a scrambled keypad. In other example embodiments, the data comprises an image of a scrambled keypad. An example illustration of a scrambled keypad is illustrated in FIG. 5 of the drawings. The scrambled keypad is similar to conventional keypads in that it has a matrix with zones or locations for at least digits, characters, or symbols. However, instead of the conventional keypad layout, the scrambled keypad has a scrambled arrangement of digits as illustrated in FIG. 5. It will be noted that the conventional or defined normal keypad layout mentioned may be a keypad layout associated with most mobile telephones and an example of such a layout of digits on the conventional keypad is illustrated in a keypad shown in FIG. 6.

In any event, the user is able to enter a PIN using either the keypad of their telephone, keyboard or their computer or a keypad shown to them on a graphical user interface for example.

In one example embodiment the system 12 is arranged to transmit a code receiving message, for example the code receiving message illustrated in FIG. 6 or preferably FIG. 7, to the user 14 via the first communication network 18 to prompt the user 14 for their PIN code. The code receiving message could also be a scrambled keypad such as the one illustrated in FIG. 5 which is displayed to the user via a graphical user interface on their mobile telephone or computer, for example.

As previously mentioned, the code receiving message of FIG. 6 comprises a conventional keypad, as illustrated, on which the user 14 is prompted to enter their PIN as per the scrambled keypad. It follows that the code receiving message may therefore be a pop-up message on the user's PC using metaframe. The pop-up message may include clickable buttons or zones for the user to enter their scrambled PIN thereon. It will be appreciated that in a preferred example embodiment as illustrated in FIG. 7 the keypad in the pop-up message may not illustrate the digits on the keypad at all. In other words the keypad is blank. Alternatively, the keypad may be the scrambled keypad as per the data transmitted to the user so that the user is able to select keys directly on the scrambled keypad shown to them.

The user selects keys to enter their PIN and these are transmitted back to the system 12. It will be appreciated that the user will be selecting alphanumeric characters corresponding to their original PIN that is known to them and so from a user's point of view the PIN will not be changing. However, the PIN that will be transmitted back to the system will always be different depending on the layout of the scrambled keypad. This is a secure feature of the system as the original PIN is not transmitted over the network.

For example, referring to FIG. 5, if the real PIN is 1234 the user will select the keys which are marked 1, 2, 3 and 4 on them but as these are in locations 4, 6, 2 and 7 of a normal keypad the PIN that will actually be transmitted back to the system is 4627.

In any event, the code receiver module 28 receives a PIN entered by a user using the scrambled keypad wherein the received PIN is made up of alphanumeric characters of a normal keypad corresponding to the keys selected by the user on the scrambled keypad as has been described above, i.e. 4627 in this example.

A descrambling module 30 checks that the received PIN matches the user PIN stored in the memory. In one example embodiment, the system 12 further comprises a descrambling module 30 communicatively coupled to the code receiver module 28, the descrambling module 30 being arranged to descramble the scrambled PIN code by way of a key associated with the transmitted security message thereby to obtain the unique PIN code associated with the user 14 from the received scrambled PIN code. Thus the descrambling module is able to convert the number 4627 back to 1234 in the present example.

Alternatively, at the time the scrambled keyboard is sent to the user the scrambled PIN can be stored in a memory such as database 24 and then to authorize the transaction the scrambled PIN is checked to see if it matches the scrambled PIN stored in the memory.

The system also includes a processor 32 arranged at least to generate the identification messages; the scrambled keypad data and corresponding descrambling keys; and code receiving messages.

The processor 32 is arranged to control the operation of the system 12. The processor 32 is also arranged to store the generated data in the database 24 as well as identity of the user 14. This conveniently allows the system 12 to determine which key to use to descramble a received scrambled PIN code from a particular user 14.

In one example embodiment, the system 12 can be arranged to transmit the descrambled unique PIN code to a relevant party for example the bank 21 so as to facilitate the transaction between the user 14 and the vendor 16.

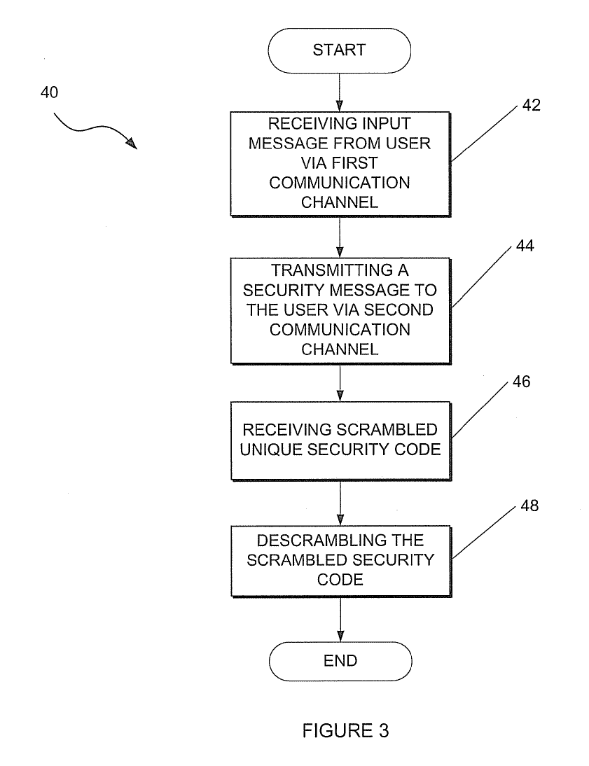

Example embodiments will now be further described in use with reference to FIGS. 3 to 6. The example method shown in FIG. 3 is described with reference to FIGS. 1 and 2, although it is to be appreciated that the example methods may be applicable to other systems (not illustrated) as well.

Referring to FIG. 3 of the drawings where a flow diagram of a method in accordance with an example embodiment is generally indicated by reference numeral 40.

When a user 14 conducts a transaction online or a web-based transaction they typically select good and/or services offered by the vendor 16 which they intend on purchasing.

Once a selection is made, the user 14 has an option to pay for selected goods and/or services online. This is conveniently where the security system 12 comes into operation to protect at least a PIN code associated with a bank account of the user 14 while transmitting such data to pay for purchased goods and/or service online.

As previously mentioned, an identification message is initially transmitted to the user 14 via the first communication network 18. It will be noted that the identification message illustrated in FIG. 4 prompts the user for their MSISDN or mobile telephone number. It will be noted that in other example embodiments, this data may already be stored on the database 24. In other example embodiments (not shown) the method may include a step of registering a user 14 to use the system 12.

The identification message may be typically generated by the processor 32. The method 40 comprises receiving, at block 42 via the module 22, the input message from the user 14 via the first communication network 18 as hereinbefore described.

The method 12 then comprises transmitting, at block 44 via the transmitter 26, a security message to the user 14 via a second communication network 20, the security message comprising at least data including information indicative of a scrambled keypad as illustrated in FIG. 5. As hereinbefore mentioned, the security message may be an SMS message which is sent to the mobile telephone of the user 14 using the MSISDN from the input message for example. It will again be noted that the transmission of the security message over a different communication network to the one being used for the transaction inherently increases the security of the present system. As a fraudster hacking into the users 14 PC would still not be able to determine the PIN code of the user 14 as they would not have the security message to descramble the scrambled PIN code.

The security message is generated by the processor 32 together with a key to descramble a received scrambled PIN (described below). It will be noted that the security message or information associated with the scrambled keypad, the key and the identity of the user is stored in the database 24 to allow the system 12 to determine which security message was transmitted to the user 14.

The method 12 further comprises the step (not shown) of transmitting a code receiving pop-up message as illustrated in FIG. 6 or 7 to the user 14 via the first communication network 18. In a preferred example embodiment the code receiving message comprises a blank keypad (as illustrated in FIG. 7) which a user 14 would use to enter their PIN code is accordance with the scrambled keypad.

For clarity, an example of a scrambled PIN code will be discussed with reference to FIGS. 5 and 6 or 7 in particular. If the PIN code of the user 14 is 1234 then the user 14 would look to the scrambled keypad in the SMS transmitted to them. With reference to the scrambled keypad illustrated in FIG. 5 it will be noted that the code 1234 corresponds to the 4^{th}, 6^{th}, 2^{nd}, and 7^{th} keys of the scrambled keypad respectively. The user 14 would then enter in his PIN code on the pop-up keypad in accordance with the positions of digits on the scrambled keypad, in other words, the user 14 would enter the 4^{th}, 6^{th},2^{nd}, and 7^{th} keys on the keypad (corresponding to the PIN code of 1234) of the pop-up message which would result in a scrambled PIN code of 4627.

It follows that the method 40 comprises receiving, at block 46 via the code receiver module 28 over the first communication network 18, a message from the user 14 comprising at least the scrambled PIN code corresponding to the scrambled keypad for example the scrambled PIN 4627 as previously described.

The method 40 then in one example embodiment comprises descrambling, at block 48 via the descrambling module 30, the scrambled PIN code by way of a key associated with the transmitted security message to obtain the unique PIN code associated with the user.

The key typically allows the system 12 to determine which scrambled keypad was transmitted to the particular user 14. Once it is determined which scrambled keypad was transmitted to the user 14, the descrambling module 40 determines the corresponding PIN code by having regard to the number or symbol on the scrambled keypad corresponding to each of the digits of the scrambled PIN. For example where the scrambled PIN is 4627, the descrambling module 40 determines which numbers are on the 4^{th}, 6^{th}, 2^{nd}, and 7^{th} keys of the scrambled keypad which was transmitted to the user 14. The unique PIN code of 1234 associated with the bank account of the user 14 may therefore be obtained in this fashion.

It is the scrambled PIN code and not the PIN code itself which is advantageously transmitted over the network 18. This would mean that should a fraudster get hold of the scrambled PIN code, by hacking the users 14 PC for example, they would not be able to use the scrambled PIN code as they would not have the scrambled keypad to allow them to descramble the scrambled PIN.

The descrambled PIN code is then transmitted to the bank 21 to facilitate payment to the vendor 16 for goods and/or service purchased by the user 14.

Alternatively another message could be sent to the bank to confirm that the PIN code was correct rather than sending the PIN code itself.

In other example embodiments, the system 12 is arranged to authenticate the descrambled PIN code of the user 14.

It will be appreciate that the invention as hereinbefore described is merely one example embodiment of the invention and the invention may also be used for any other PIN entry scenario over the Internet, telephone (both mobile and landline), PDA (Personal Digital Assistant), set-top box, ATM (Automated Teller Machine), POS (Point of Sale) device, kiosk, appliances, safes, or the like.

The invention as hereinbefore described provides a more secure system to receive and process security PIN codes. It will be noted that the unique PIN code associated with a user is never entered and transmitted via the Internet thereby reducing the opportunity for fraud. The invention conveniently provides out-of-band, multi-factor authentication. Keyloggers and screen-scrapers used by fraudsters to obtain security PIN codes will be rendered ineffective in light of the present invention as only the scrambled PIN code is entered.

1. A method of operating a security system, the method comprising:
accessing a database and obtaining a user PIN;
defining a normal keypad in which a plurality of alphanumeric characters are displayed in defined normal positions;
defining a scrambled keypad including the PIN so that at least some of a plurality of alphanumeric characters are displayed on the scrambled keypad in positions which are different to the positions in which they would be displayed in the defined normal keypad;
determining for each of the alphanumeric characters of the PIN the alphanumeric character which is normally displayed in the normal keypad in the position in which the alphanumeric characters of the PIN are displayed in the scrambled keypad thereby to arrive at a scrambled PIN;
transmitting data defining the scrambled keypad to a user over a first communications network so that the scrambled keypad can be displayed to the user; and
receiving a PIN entered by a user using the scrambled keypad wherein the received PIN is made up of alphanumeric characters of a normal keypad corresponding to keys selected by the user based on the displayed scrambled keypad.

2. A method according to claim 1, the method further comprising checking that the received PIN is correct and authorizing a transaction only if the received PIN is correct.

3. (canceled)

4. A method according to claim 1, the method further comprising receiving an input message from a user via a second communication channel, the input message relating at least to a transaction which requires a PIN associated with the user.

5. A method according to claim 4 wherein the input message comprises at least information to identify the user.

6. A method according to claim 4 wherein the method includes determining an identity of the user from the received input message.

7. (canceled)

8. A method according to claim 1 wherein the received PIN is received via a second communication network.

9. A method according to claim 8 wherein the second communication network is a cellular or mobile telecommunication network.

10. A method according to claim 9 wherein the method includes transmitting the data defining the scrambled keypad to a cellular or mobile telephone associated with the user.

11. A method according to claim 1 wherein the received PIN is checked for correctness by comparing the received PIN with a scrambled PIN stored in a memory.

12. A method according to claim 1 wherein the received PIN is checked for correctness by converting the received PIN using the scrambled keypad sent to the user and then comparing the converted received PIN with the PIN stored in the database.

13. A security system comprising:
a database;
a processor to:
access the database and obtain a user PIN;
define a normal keypad in which a plurality of alphanumeric characters are displayed in defined normal positions;
define a scrambled keypad including the PIN so that at least some of a plurality of alphanumeric characters are displayed on the scrambled keypad in positions which are different to the positions in which they would be displayed in the defined a normal keypad; and
determine for each of the alphanumeric characters of the PIN the alphanumeric character which is normally displayed in the normal keypad in the position in which the alphanumeric characters of the PIN are displayed in the scrambled keypad thereby to arrive at a scrambled PIN;
a transmitter to transmit data defining the scrambled keypad to a user over a first communications network so that the scrambled keypad can be displayed to the user; and
a receiver module to receive a PIN entered by a user using the scrambled keypad wherein the received PIN is made up of alphanumeric characters of a normal keypad corresponding to keys selected by the user based on the displayed scrambled keypad.

14. A system according to claim 13, the processor further comprising checking that the received PIN is correct and authorizing a transaction only if the received PIN is correct.

15. (canceled)

16. A system according to claim 13, further comprising a message receiving module for receiving an input message from a user via a second communication channel, the input message relating at least to a transaction which requires a PIN associated with the user.

17. A system according to claim 16 wherein the input message comprises at least information to identify the user.

18. A system according to claim 16 wherein the processor determines an identity of the user from the received input message.

19. (canceled)

20. A system according to claim 13 wherein the received PIN is received via a second communication network.

21. A system according to claim 20 wherein the second communication network is a cellular or mobile telecommunication network.

22. A system according to claim 13 wherein the processor checks the received PIN for correctness by comparing the received PIN with a scrambled PIN stored in a memory.

23. A system according to claim 13 wherein the processor checks the received PIN for correctness by converting the received PIN using the scrambled keypad sent to the user and then comparing the converted received PIN with the PIN stored in the database.
